(19) United States
(12) Patent Application Publication
(10) Pub. No.: US 2009/0267746 A1
(43) Pub. Date: Oct. 29, 2009

(54) Multi-Port Receiver

(75) Inventor: Artem MUCHKAEV, Glen Waverley (AU)

Correspondence Address: HOGAN & HARTSON L.L.P., 1999 AVENUE OF THE STARS, SUITE 1400, LOS ANGELES, CA, 90067, US

(73) Assignee: MARTEC CORPORATION, Las Vegas, NV (US)

(21) Appl. No.: 12/108,322

(22) Filed: Apr. 23, 2008

(51) Int. Cl. G08C 17/02; H04L 27/06; H04B 1/69

(52) U.S. Cl. 340/10.4; 375/316; 375/130; 375/E01.001

(57) ABSTRACT

A multi-port receiver with a sophisticated signal processing technique for demodulating radiofrequency (RF) modulated digital signals that simplifies the multi-port receiver hardware. A section of a transmission line with coupling probes is used as a six-port circuit. Fixed probes distributed along the transmission line sample the resulting wave pattern at different phase shifts and the outputs of the probes are connected to power detectors. Statistical digital processing of the detector outputs recovers the transmitted signal. Power dividers and hybrid couplers are not required.

### FIELD OF THE INVENTION

The present invention generally relates to communication systems and more particularly to a direct conversion receiver and method based on six-port technology. The present invention is further directed to a mobile communication device and a RFID reader comprising such a receiver.

### BACKGROUND

Six-port technology promises to be a cheap and extremely broadband alternative to conventional direct conversion receivers. A combination of software defined radio and six-port technology provides flexible system configuration, significant reduction in hardware cost and low fabrication requirements. The performances of six-port circuits in digital receivers show promising applications of six-port technology for direct digital conversion demodulation reception.

According to six-port theory, input signals are added and the resulting sum is nonlinearly processed (squared), e.g. by using the current-voltage characteristic of a diode. A common method of six-port receiver realization is shown in FIG. 1 where the receiver architecture is separated in an analog and a digital part of the front-end. An incoming radiofrequency (RF) signal received from antenna 20 is band pass filtered 21 and amplified by a low-noise amplifier 22, and then enters six-port passive circuit 23. Six-port 23 circuit mixes additively the band pass filtered/amplified input and a local oscillator signal (generated by voltage controlled oscillator 27) under four different phase conditions. Power detector 24 contains, for example, a diode detector with appropriate low pass filtering to detect the power of each six-port output and an additional amplifier (not shown) that is used to match the input range of analog-digital converter (ADC) 25.

Six-port circuit 23 performs four independent phase shifts using 90°-hybrid couplers as shown in FIG. 2. RF band pass signal 31 and local oscillator 32 are connected to the two inputs of the circuit. Using 90 degree couplers 33-35 and a power divider 36, signals 31 and 32 can be mixed under four different phase conditions. The four resultant signals at outputs 37a, 37b, 37c and 37d are detected by the power detectors, and each detector output is then digitized as in FIG. 1 by analog-to-digital converters (ADCs) into an observation yᵢ.

The components of the complex baseband signal are calculated in digital domain by using the set of digital observations yᵢ, where

yᵢ=|Aᵢ|²|a|²+|Bᵢ|²|b|²+2|Aᵢ∥Bᵢ∥a∥b|cos(2π(ƒₐ−ƒ_{b})t+Δψᵢ+Δφ) (1)

### Here

Aᵢ=|Aᵢ|e^{jψ}^{ₐₗ},Bᵢ=|Bᵢ|e^{jψ}^{_{Bl}} are complex functions of the six-port parameters, a=|a|e^{jφ}^{ₐ}, b=|b|e^{jφ}^{_{b}} are complex amplitudes of the “incident” and “reflected” waves at some port (e.g. port to which the RF signal is fed as shown in FIG. 1) with generally different frequencies ƒₐ, ƒ_{b}, respectively.

$${Δψ}_{i} = arg ( \frac{{B}_{i}}{{A}_{i}} ) , Δ ϕ = arg ( \frac{b}{a} ) .$$

For M-PSK (phase shift keying) or M-QAM (quadrature amplitude modulation) receivers, (1) can be represented as

yᵢ=K₁(I²(t)+Q²(t)+Cᵢ²)+K₂(I(t)cos(2π(ƒ₀−ƒ_{c})t+φᵢ)+Q(t)sin(2π(ƒ₀−ƒ_{c})t+φᵢ)) (2)

where I(t) and Q(t) represent the incoming signal components, ƒ₀, ƒ_{c}, are local oscillator and input RF signal frequencies respectively and φᵢ is a phase difference between the carrier and the local oscillator. K₁, K₂, and Cᵢ represent imperfections in the hardware implementation such as phase errors of the branches, imbalance of the power detectors, insertion loss, etc. as understood by those in the art.

In order to demodulate the incoming signal and recover the desired (but as yet unknown) signal components I and Q, appropriate post-detection signal processing must be performed on the set of observations yᵢ. For a general set of φᵢ, ƒ₀ and ƒ_{c}, equations (1) and (2) can be impossible to solve even analytically, let alone implemented in hardware. Therefore, as is known in the art, one must make a deliberate choice for these parameters to render the linear equations invertible, i.e. to obtain a non-singular matrix. This is accomplished by choosing nominal values of φᵢ=[0°, 90°, 180°, 270°] and assuming ƒ₀=ƒ_{c}. Furthermore, K₁, K₂, Cᵢ, can be determined using a calibration procedure known by those skilled in the art as a “preamble”, where a known set of symbols are sent in the procedure. Once the calibration is complete, one is then left with a system of at least three and particularly four equations describing the observations yᵢ that can be solved to obtain the wanted signal components I and Q.

However, as explained above, the disadvantage of the conventional signal processing method is that it necessitates hybrid couplers and power dividers that make the six-port receiver complicated and also increase fabrication costs.

### SUMMARY

The present invention addresses these disadvantages of the conventional art and provides a simplified multi-port receiver hardware with a more sophisticated signal processing technique for demodulating radiofrequency (RF) modulated digital signals such as phase shift keying (PSK) or quadrature amplitude modulation (QAM) signals. In contrast to a conventional six-port receiver, a section of a transmission line (e.g., a section of microstrip) with coupling probes is used as a six-port circuit. Fixed probes distributed along the transmission line sample the resulting wave pattern at different phase shifts and the outputs of the probes are connected to power detectors. In contrast to prior art configurations, the effective phase shifts sampled along the transmission line are broader, and need not be limited to the set [0°, 90°, 180°, 270°]. Compared to six-port receivers in the prior art, the present invention is simplified since it does not require power dividers and hybrid couplers.

Improved digital signal processing is performed to demodulate the incoming signal. Prior art methods are restricted to the phase shifts discussed above so that the system of linear equations is invertible and hence solvable analytically. According to the present invention, simplified circuitry leads to a set of linear equations that cannot be solved using prior art signal processing techniques. However, the inventor has recognized that this novel signal processing problem can be cast as an optimization problem, and is thus solvable by statistical methods using iterative algorithms. A calibration procedure is used to account for hardware imperfections. Statistical digital signal processing has the further advantage that measurement errors are explicitly accounted for, which improves the error rate of the device. Another advantage of the more advanced signal processing of the present invention is that the number of output ports that need to be detected may be reduced. This leads to further cost savings in the manufacturing process, as well as a more compact device.

This would not be possible using prior art signal processing techniques as eliminating the detection of an output port will leave a non-solvable system of linear equations because there would be more unknowns than equations.

The invention can be implemented to receive any REF modulated signal, preferably microwave and higher frequency signals including ultra-wide band (UWB) multi-band and impulse signals. The present invention can also be implemented as a low cost RFID reader within a radiofrequency identification (RFID) system.

### BRIEF DESCRIPTION OF THE DRAWINGS

FIG. 1 is a block diagram of a six-port receiver architecture.

FIG. 2 is a block diagram of a six-port component of the six-port receiver architecture of FIG. 1.

FIG. 3a is a block diagram of an N-port receiver according to the present invention. FIG. 3b illustrates an optimization problem solution algorithm.

FIGS. 4a and 4b are block diagrams of RFID reader-transponder system configurations according to the present invention.

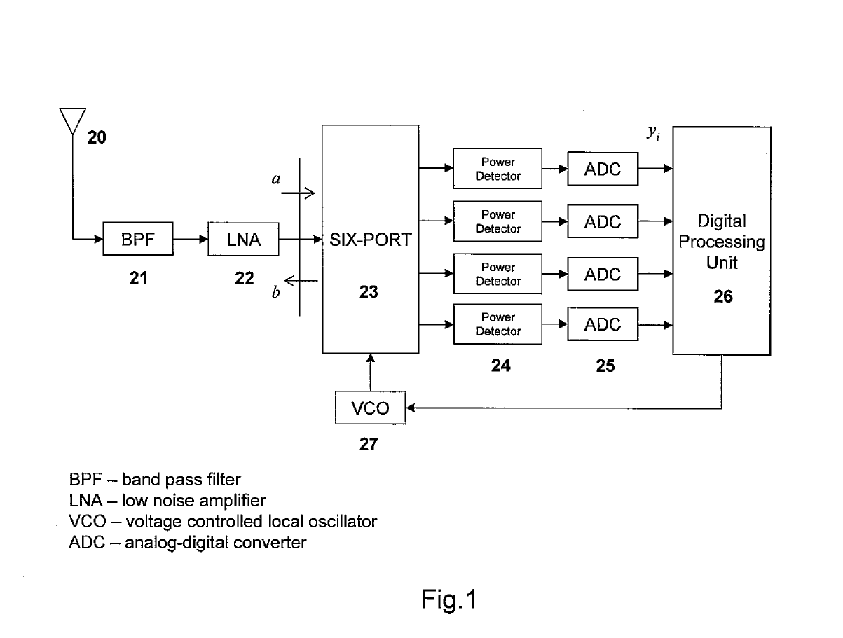

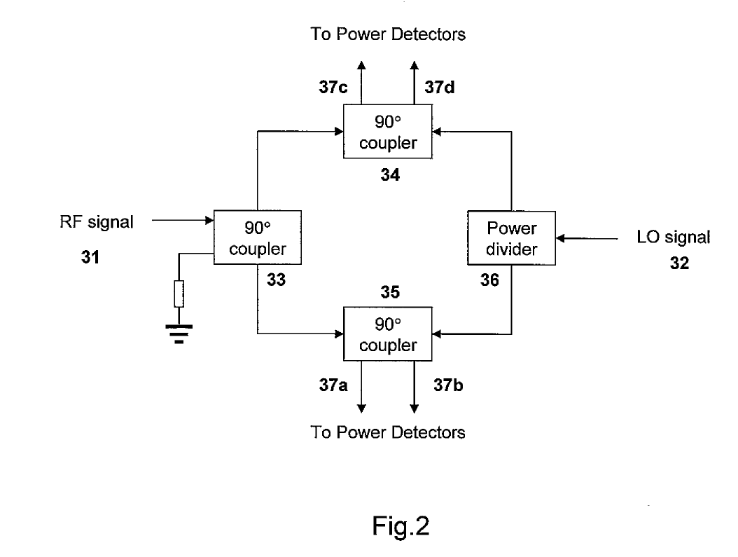

### DESCRIPTION OF EMBODIMENTS OF THE INVENTION

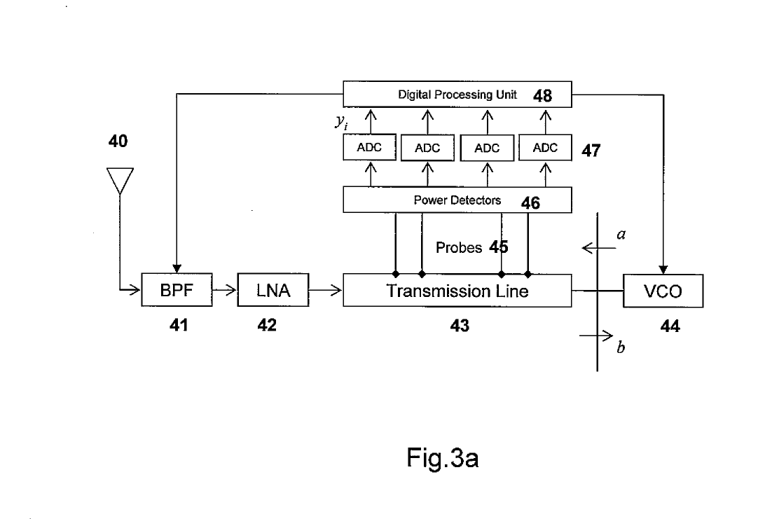

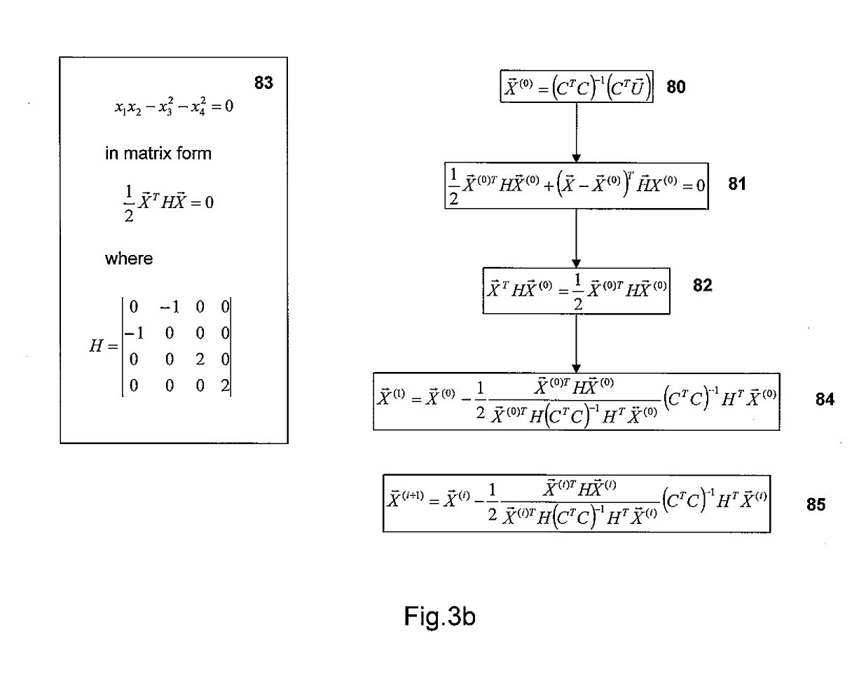

Enhanced signal processing according to the present invention allows greater flexibility in the hardware implementation of a receiver. In the following description, the term “N-port” or “multi-port” is used to emphasize that although the present invention relates to six-port technology, it is not limited to six-port receiver configurations. FIG. 3 is a block diagram of an N-port receiver based on a multiprobe reflectometer according to an embodiment of the present invention. An incoming radiofrequency (RF) signal received from antenna 40 is filtered by a band pass filter 41, amplified by a low-noise amplifier 42, and then coupled into a transmission line 43. In the illustrated embodiment, the N-port receiver is implemented as a multiprobe reflectometer with N−2 fixed probes 45 sampling the wave pattern on transmission line 43, which is connected to a load, such as a local oscillator 44. A local oscillator is not specifically required, and any load that reflects the signal is sufficient. For example, different phase shift values can be introduced by choosing load 44 to have an appropriate complex reflection coefficient, thus simplifying the calibration procedure and signal demodulation. Transmission line 43 may be rectangular in plan view, or of any desired shape subject to space limitation. The device can be easily built in microstrip and monolithic implementations and configured according to a package. Also, the device can be implemented as an antenna embedded transmission line. Probes 45 are connected to power detectors 46, and digitized by ADCs 47 into digital observations yᵢ for further signal processing in digital processing unit 48.

In the case of M-PSK/M-QAM communication the digital observations yᵢ can be defined as

$${y}_{i} = {\vert {A}_{i} \vert}^{2} {\vert a \vert}^{2} + \frac{1}{2} {\vert {B}_{i} \vert}^{2} ( {I}^{2} + {Q}^{2} ) + 2 \vert {A}_{i} \vert \vert {B}_{i} \vert \vert a \vert cos ( Δ {ψ}_{i} ) ( I cos ( Δ ϕ ) - Q sin ( Δ ϕ ) ) - 2 \vert {A}_{i} \vert \vert {B}_{i} \vert \vert a \vert sin ( {Δψ}_{i} ) ( I sin ( Δ ϕ ) - Q cos ( Δ ϕ ) ) + {Δ}_{i} \qquad ( 3 )$$

where Δᵢ is measurement error of the i-th power detector. Assume that ƒ₀=ƒ_{c} for simplicity since, in general, ƒ₀−ƒ_{c}=const and can be included into Δφ.

It is easy to represent (3) as

$${y}_{i} = \begin{matrix}{\sum }_{k = 1}^{4} {c}_{ki} {x}_{k} + {Δ}_{i} , & i = \overline{1 , K}\end{matrix} \qquad ( 3 a )$$

where K is a number of probes and

$$\begin{matrix}\begin{matrix}{c}_{1 i} = {\vert {A}_{i} \vert}^{2} \\ {c}_{2 i} = \frac{1}{2} {\vert {B}_{i} \vert}^{2} \\ {c}_{3 i} = 2 \vert {A}_{i} \vert \vert {B}_{i} \vert cos ( Δ {ψ}_{i} ) \\ {c}_{4 i} = - 2 \vert {A}_{i} \vert \vert {B}_{i} \vert sin ( Δ {ψ}_{i} )\end{matrix} & ( 4 ) \\ \begin{matrix}{x}_{1} = {\vert a \vert}^{2} \\ {x}_{2} = ( {I}^{2} + {Q}^{2} ) \\ {x}_{3} = \vert a \vert I cos ( Δ ϕ ) - \vert a \vert Q sin ( Δ ϕ ) \\ {x}_{4} = \vert a \vert I sin ( Δ ϕ ) + \vert a \vert Q cos ( Δ ϕ )\end{matrix} & ( 5 )\end{matrix}$$

The coefficients Cₖᵢ from (4) include hardware imperfections and amplifiers' gains and can be determined by the calibration procedure. In general, the calculation of the complex baseband signal s=I+jQ (where j=\sqrt{−1}) requires four power measurements. Additional power detectors increase the estimation accuracy of the receiver.

Bearing in mind the random nature of measurement errors, the values xᵢ can be estimated using statistical methods. The equation system (6) is solved within digital processing unit 48:

$$\{ \begin{matrix}e ( {x}_{1} , {x}_{2} , {x}_{3} , {x}_{4} ) = min {\sum }_{i = 1}^{N} {( {y}_{i} - {\sum }_{k = 1}^{4} {c}_{ki} {x}_{k} )}^{2} \\ {x}_{1} {x}_{2} - {x}_{3}^{2} - {x}_{4}^{2} = 0\end{matrix} \qquad ( 6 )$$

(6) is an optimization problem with limitation and the estimates \hat{x}ᵢ can be obtained by use of numerical computing methods with iterative procedures. As an example (refer to FIG. 3b), as a null approximation 80, estimates obtained from (3a) can be taken without the equality constraint in (6), expressed in matrix form 83. This can be accomplished using Least Square Method with |Δᵢ|<<yᵢ, (i=1:K) assumption. Taylor's expansion of constraint 83 provides linearization 81, 82 from which a Lagrangian multiplier method is applied to calculate estimates 84 required. Additional iterations 85 will improve the accuracy of the estimates (for example, refer to: Vuchkov, I., Boyadzhieva, L., and Solakov, E., Prilozhen lineen regresonen analiz (Applied Linear Regression Analysis), Sofia: Tekhnika, 1984. I. Vuchkov, L. Boyadzhieva and E. Solakov, Applied Linear Regression Analysis, Financy i statistika, Moscow, 1987. In Russian). In general, any suitable iterative algorithm is applicable for the types of optimization problems under consideration as the null approximation 80 (starting point) is sufficiently close to an estimate due to relatively small measurements errors inherent in the multi-port circuit configuration. Using 80 as a starting point, the iterative algorithm can typically be stopped after the N=2 iteration to get the required accuracy and reduce estimation time.

Any digital signal processor can be used to implement the signal processing, e.g. TI, Analog Devices, ARM9 processor. FPGA and ASIC can be used as well, which provide the advantages of high speed calculations and small form-factor.

The present invention can receive and demodulate signals from other modulation schemes, such as amplitude and phase modulation signals. In this case the digital observations are described by

yᵢ=|Aᵢ|²|a|²+|Bᵢ|²|b|²+2|Aᵢ∥Bᵢ∥a∥b|cos(Δψᵢ+Δφ (7)

and (6) should be solved with respect to the wave b for AM and phase Δφ for PM, where

$$\begin{matrix}\begin{matrix}{c}_{1 i} = {\vert {A}_{i} \vert}^{2} \\ {c}_{2 i} = \frac{1}{2} {\vert {B}_{i} \vert}^{2} \\ {c}_{3 i} = 2 \vert {A}_{i} \vert \vert {B}_{i} \vert cos ( Δ {ψ}_{i} ) \\ {c}_{4 i} = - 2 \vert {A}_{i} \vert \vert {B}_{i} \vert sin ( Δ {ψ}_{i} )\end{matrix} & ( 8 ) \\ \begin{matrix}{x}_{1} = {\vert a \vert}^{2} \\ {x}_{2} = {\vert b \vert}^{2} \\ {x}_{3} = \vert a \vert \vert b \vert cos ( Δ ϕ ) \\ {x}_{4} = \vert a \vert \vert b \vert sin ( Δ ϕ )\end{matrix} & ( 9 )\end{matrix}$$

This invention is not limited to any particular modulation scheme, and the embodiments described herein are for illustrative purposes only, and not intended to limit the scope of coverage in any way. Modulation schemes, such as M-PSK, DPSK, M-QAM, AM, ASK, OOK, PM, FM and their variations such as MSK, GMSK can all benefit from the disclosed invention in a way that will be understood by those of skill in the art.

### RFID Reader-Transponder Embodiment

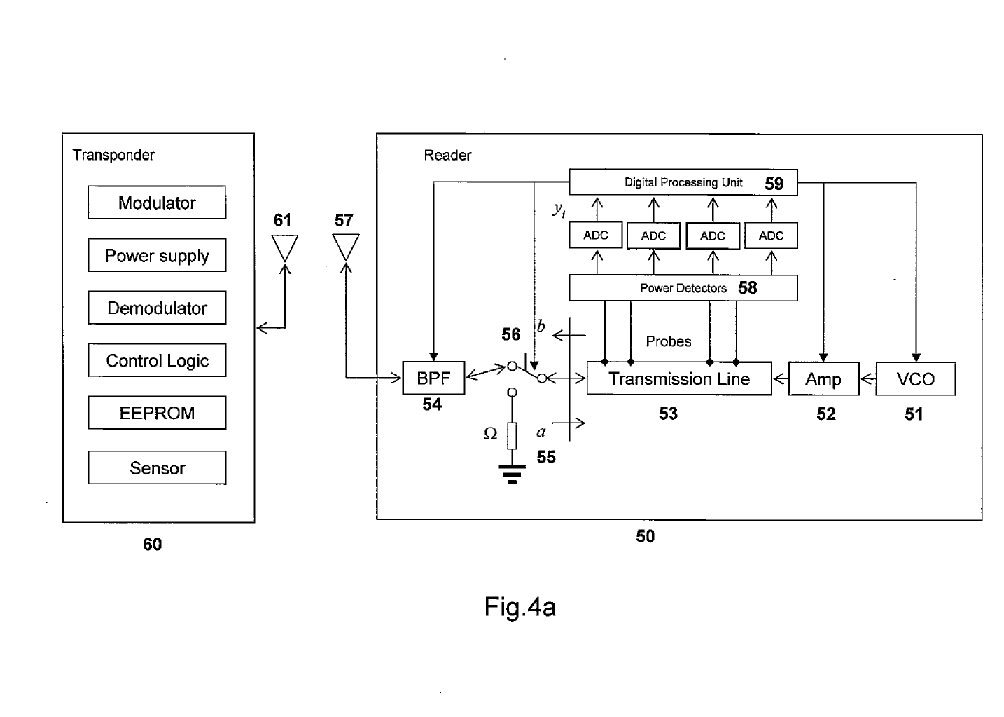

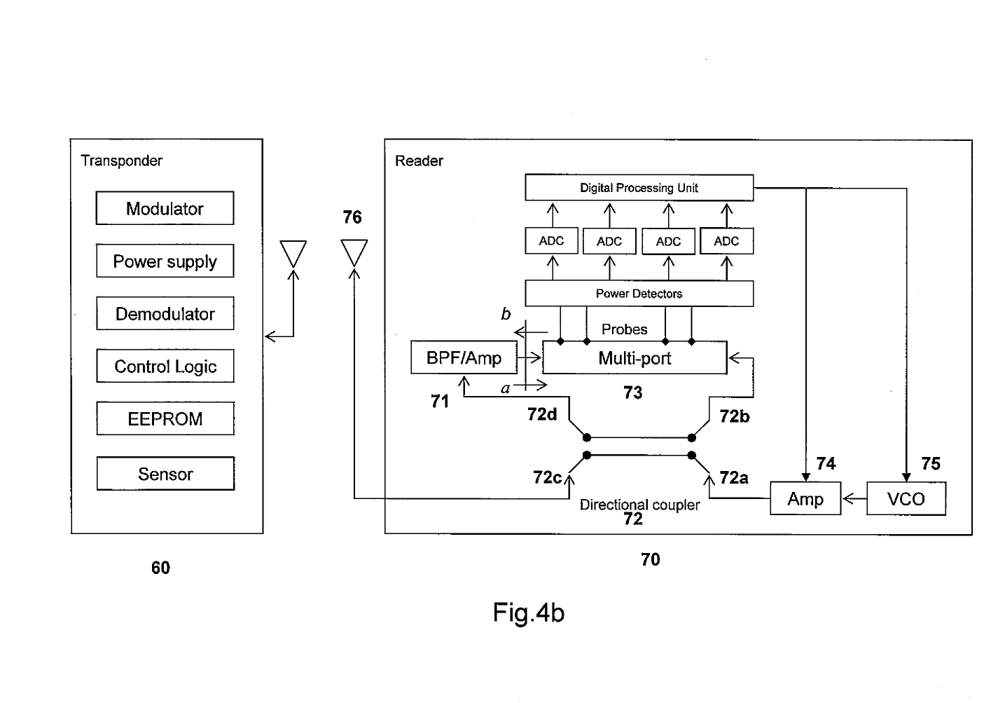

FIG. 4a shows an RFID system architecture according to another embodiment of the present invention. The RFID system consists of at least one transponder 60 or tag which is located on an object to be identified and a reader 50, which may be a read or read/write device. As shown, transponder 60 comprises an EEPROM, control logic, a demodulator, a power supply, a modulator and a sensor(s).

In reader 50, the carrier signal is generated by voltage controlled oscillator 51, amplified by amplifier 52 and sent through a transmission line 53 as a multi-port circuit, and then through a reciprocal band pass filter 54 to reader antenna 57. Reader antenna 57 emits power, a small proportion of which reaches antenna 61 of transponder 60 because of free space attenuation.

Transponder antenna 61 reflects (backscatters) part of the power of the carrier signal transmitted by reader 50 at the scatter aperture of the transponder antenna. In order to send data from transponder 60 to reader 50 the input impedance of transponder 60 is varied in time with the data stream. Varying the input impedance of transponder 60 results in modulation of the amplitude and/or phase of the reflected (backscatter) signal. Thus, transponder 60 can perform phase, amplitude and mixed phase/amplitude modulation and reader 50 can operate PSK, ASK and I/Q demodulation. The reflected (backscatter) signal reaches reader antenna 57 for demodulation by RFID reader 50.

As before, equations (3, 4, 5, and 6) are applied to estimate the components I and Q of complex received signal. For ASK and PSK modulation the digital observations yᵢ are represented by (7). Solving (6) with (8) and (9), one can estimate amplitude α and phase Δφ of the transponder signal.

Thus, the RFID reader architecture is simplified and fabrication cost is reduced. Another advantage of this embodiment is that the number of power detectors can be less than four, further decreasing manufacturing cost. Since the backscatter signal α is relatively weak it can be reasonably neglected and (7) can be represented as (10):

yᵢ=|Bᵢ|²|b|²+2|Aᵢ∥Bᵢ∥a∥b|cos(Δψᵢ+Δφ) (10)

The term ∥Bᵢ|²|b|² can be estimated by switching transmission line 53 using switch 56 to matching load Ω 55 which eliminates the reflected component α, as is known by those of skill in the art. Finally, these relationships can be represented in (11):

uᵢ=2|Aᵢ∥a|cos(Δψᵢ+Δφ) (11)

and readings from only two ports are enough to solve (11) with respect to amplitude α and phase Δφ provided with suitable calibration condition. However, additional ports readings will increase the accuracy of the amplitude and phase estimation.

### RFID Reader-Transponder with Directional Coupler Embodiment

Some microwave RFID readers employ a directional coupler to separate the reader's transmitted signal from weak backscatter signal of the transponder. A directional coupler is described its directivity and coupling loss. A directional coupler for a backscatter RFID reader should have maximum possible directivity to minimize the decoupled signal of the transmitter arm (“RFID Handbook”, Klaus Finkenzeller REID handbook: fundamentals and applications in contactless smart cards and identification/Klaus Finkenzeller, 2-nd edition, WILEY. ISBN 0-470-84402-7). On the other hand, the coupling loss should be low to decouple the maximum possible proportion of the received signal from the transponder to the receiver arm. It is necessary to ensure that the transmitter antenna is well matched to the reader's RF front end; otherwise a transmitted signal reflected from the antenna due to poor matching is decoupled at the receiver arm as backward power. If the directional coupler has a high coupling loss, even the smallest mismatching of the transmitting antenna (e.g. by environmental influences) is sufficient to deteriorate the backscatter transponder signal.

Another embodiment of an RFID reader 70 allowing performance improvement according to the present invention is shown in FIG. 4b. In RFID reader 70, decoupled port 72d of directional coupler 72 is connected to a bandpass filter and a low noise amplifier 71 which is connected, in turn, to a first port of a multi-port circuit 73, e.g. a transmission line. The second port of the multi-port circuit 73 is connected to matched port 72b of directional coupler 72. In the transmitting arm of reader 70, input port 72a of directional coupler 72 is connected to an amplifier 74 and a local oscillator 75. Output port 72c of directional coupler 72 is connected to an antenna 76. Other ports of the multi-port circuit are connected to power detectors, amplifiers and a digital processing unit as explained above.

In the RFID reader embodiment, antenna mismatching caused by physical imperfections and environmental influences as well as the directional coupler's imperfections do not deteriorate demodulation of the backscatter signal from the transponder. The RFID reader utilizes the decoupled signal of the transmitted arm instead of its suppression and combines it with backscatter signal.

In order to demodulate the backscatter signal from the transponder, the digital observations yᵢ (7) are used. Solving (6) with (8) and (9), one can estimate amplitude α and phase Δφ of the backscatter transponder signal.

1. A receiver for demodulating RF modulated signals, comprising:
an analog front end having an input and an output;
a multi-port circuit having input ports and output ports; and
a digital back end having power detectors, analog-digital converters and a digital processing unit, wherein
the RF modulated signals are electrically connected to the input of the analog front end;
the output of the analog front end is electrically connected to a first input port of the multi-port circuit;
the output ports of the multi-port circuit are electrically connected to the power detectors of the digital back end;
the power detectors output detected signals that are digitized by the analog-digital converters;
the analog-digital converters output digital observations to the digital processing unit; and
the digital processing unit implements numerical computing methods with iterative procedures to solve an optimization problem.

2. The receiver of claim 1 wherein the multi-port circuit is a section of a transmission line, and the output ports are probes that sample different points on the transmission line.

3. The receiver of claim 2 wherein a local oscillator is electrically connected to a second input port of the multi-port circuit.

4. The receiver of claim 2 wherein the RF modulated signal is a microwave or higher frequency signal.

5. The receiver of claim 4 wherein the RF modulated signal is an ultra wideband signal.

6. An RFID system, comprising:
a transponder having an antenna, a sensor, a modulator and a variable input impedance; and
an RFID reader having an antenna, a local oscillator, a multi-port circuit, and a digital back end, the digital back end including power detectors, analog-digital converters and a digital processing unit, wherein
the REID reader antenna is electrically connected to the multi-port circuit, the local oscillator transfers RE power to the multi-port circuit, the power detectors detect power levels within the multi-port circuit and output detected signals that are digitized by the analog-digital converters;
the analog-digital converters output digital observations to the digital processing unit;
the digital processing unit implements numerical computing methods with iterative procedures to solve an optimization problem; and
the RFID reader, antenna emits RF power that is variably reflected by the transponder and received by the RFID reader.

7. The RFID system of claim 6 wherein the RFID reader includes two to four power detectors, and the multi-port circuit is a section of a transmission line.

8. The RFID system of claim 6 wherein the RFID reader has multiple antennas.

9. The RFID system of claim 6, wherein the RFID reader further comprises a directional coupler having a decoupled port, a matched port, an input port and an output port, wherein
the decoupled port is electrically connected to a first port of the multi-port circuit through a bandpass filter and a low noise amplifier;
the matched port is electrically connected to a second port of the multi-port circuit;
the input port is electrically connected to the local oscillator; and
the output port is electrically connected to the RFID reader antenna.

10. An RFID system, comprising:
a transponder having an antenna, a sensor, a modulator and a variable input impedance;
an RFID reader having an antenna, a local oscillator, a multi-port circuit, a directional coupler having a decoupled port, a matched port, an input port and an output port, and a digital back end having power detectors, analog-digital converters and a digital processing unit, wherein
the decoupled port of the directional coupler is electrically connected to a first port of the multi-port circuit through a bandpass filter and a low noise amplifier;
the matched port of the directional coupler is electrically connected to a second port of the multi-port circuit;
the input port of the directional coupler is electrically connected to the local oscillator;
the output port of the directional coupler is electrically connected to the RFID reader antenna;
the power detectors detect power levels within the multi-port circuit and output detected signals that are digitized by the analog-digital converters;
the analog-digital converters output digital observations to the digital processing unit;
the digital processing unit implements numerical computing methods with iterative procedures to solve an optimization problem;
the RFID reader antenna emits RF power that is variably reflected by the transponder and received by the RFID reader.

11. The RFID system of claim 10 wherein the RFID reader includes two to four power detectors, and the multi-port circuit is a section of a transmission line.

12. The RFID system of claim 10 wherein the RFID reader has multiple antennas.
